(19) United States
(12) Patent Application Publication
(10) Pub. No.: US 2009/0128949 A1
(43) Pub. Date: May 21, 2009

(54) HEAD APPARATUS, DRIVE APPARATUS, AND TRACKING METHOD

(75) Inventors: Koji MATSUNO, Tokyo (JP); Takashi HANDA, Tokyo (JP); Osamu INOUE, Tokyo (JP); Keiji TESHIMA, Tokyo (JP); Kazutaka FUJITA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/266,812

(22) Filed: Nov. 7, 2008

(30) Foreign Application Priority Data
Nov. 15, 2007 (JP) 2007-296635

(51) Int. Cl. G11B 5/584

(52) U.S. Cl. 360/77.12; G9B/5.203

(57) ABSTRACT

A head apparatus includes: a head unit where a plurality of magnetic elements, which carry out reproducing and/or recording on data tracks on a magnetic tape, are disposed at equal intervals on a first straight line; a moving mechanism that moves the head unit; and a controller that carries out tracking control to cause the moving mechanism to move the head unit and keep the magnetic elements on the data tracks. The moving mechanism can rotate the head unit so as to increase or decrease an angle between a second straight line along a width of the magnetic tape and the first straight line. During tracking control, the controller causes the moving mechanism to rotate the head unit so as to increase or decrease the angle in accordance with changes in an interval between the data tracks and keep the respective magnetic elements on the respective data tracks.

### BACKGROUND OF THE INVENTION

1. Field of the Invention

The present invention relates to a head apparatus equipped with a head unit where a plurality of magnetic elements are disposed in a line, a drive apparatus equipped with such head apparatus, and a tracking method that keeps the magnetic elements of a head unit positioned on a plurality of data tracks on a magnetic tape.

2. Description of the Related Art

A recording medium equipped with a magnetic tape on which a large number of data tracks are provided so that a large amount of data can be recorded by recording data on the respective tracks is known. When recording and reproducing data using this type of recording medium, the narrower the track width on the magnetic tape, the higher the accuracy required for tracking that keeps a plurality of magnetic heads used for recording and reproducing on the respective tracks. As a technology for carrying out such accurate tracking, a servo control system disclosed by Japanese Patent No. 3158015 is known. In this servo control system, tracking is carried out using servo patterns for tracking servo control that are recorded on servo tracks provided along the length of the magnetic tape. More specifically, when the magnetic tape moves in the length direction thereof, a servo read head disposed on the head assembly detects the servo patterns and generates a servo read head signal that is supplied to a signal decoder. In such case, the distance between peaks that appear in the servo read head signal will change in accordance with the position of the servo read head along the width direction of the servo tracks (or magnetic tape). This means that by measuring the distances between peaks (i.e., the “burst interval” of the servo patterns), it is possible to specify the position of the servo read head on a servo track. After this, the signal decoder processes the servo read head signal to generate a position signal and supplies the position signal to a servo controller. Next, the servo controller generates a control signal and supplies the control signal to a servo mechanism of the head assembly. The servo mechanism moves the head assembly in the width direction of the servo track (magnetic tape) in accordance with the control signal. By doing so, tracking is carried out.

### SUMMARY OF THE INVENTION

However, by investigating the servo control system described above and a recording/reproducing apparatus equipped with such servo control system, the present inventors found the following problem. That is, in this type of servo control system including the servo control system described above, the head assembly is moved in the width direction of the servo tracks to carry out tracking that keeps the magnetic heads on the respective tracks. In this case, when the width of the magnetic tape is kept constant, since the interval between the tracks will also be kept constant, it will be possible to carry out accurate tracking. However, since the base tape used to manufacture a magnetic tape is constructed of a thin-film material made of resin, such base tape will lengthen and shorten to some extent due to factors such as environmental changes in temperature, humidity, and the like, and changes in the tension that is applied during use. Accordingly, in the conventional servo control system and a recording/reproducing apparatus equipped with such servo control system, when the magnetic tape lengthens or shortens, the interval between the tracks will change due to the change in length, and the interval between tracks and the interval between the magnetic heads that should fundamentally be the same will no longer match. As a result, there is the problem that accurate tracking cannot be carried out.

The present invention was conceived in view of the problem described above and it is a principal object of the present invention to provide a head apparatus, a drive apparatus, and a tracking method that are capable of accurate tracking even when a magnetic tape has lengthened or shortened.

To achieve the stated object, a head apparatus according to the present invention includes: a head unit where a plurality of magnetic elements, which respectively carry out at least one of reproducing of data recorded on a plurality of data tracks provided on a magnetic tape and recording of data on the data tracks, are disposed at equal intervals on a first straight line; a moving mechanism that moves the head unit; and a controller that carries out tracking control to cause the moving mechanism to move the head unit so that the respective magnetic elements are kept on the respective data tracks, wherein the moving mechanism is capable of rotational driving that rotates the head unit in a direction so as to increase or decrease an angle between a second straight line along a width of the magnetic tape and the first straight line, and when carrying out the tracking control, the controller causes the moving mechanism to rotationally drive the head unit so as to increase or decrease the angle in accordance with changes in an interval between the data tracks so as to keep the respective magnetic elements on the respective data tracks.

A drive apparatus according to the present invention includes the head apparatus described above; and a running mechanism that runs the magnetic tape, wherein the controller carries out the tracking control in a state where the magnetic tape is being run by the running mechanism.

A tracking method according to the present invention moves a head Unit with a plurality of magnetic elements, which respectively carry out at least one of reproducing of data recorded on a plurality of data tracks provided on a magnetic tape and recording of data on the data tracks, disposed at equal intervals on a first straight line so as to keep the respective magnetic elements on the respective data tracks, the tracking method including rotationally driving the head unit in a direction so as to increase or decrease an angle between a second straight line along a width of the magnetic tape and the first straight line by an amount in keeping with a change in an interval between the data tracks so as to keep the respective magnetic elements on the respective data tracks.

The head apparatus, drive apparatus, and tracking method according to the present invention rotate the head unit in a direction so as to increase or decrease the angle between the second straight line along the width of the magnetic tape and the first straight line in accordance with changes in the interval between the data tracks. This means that even if the interval between the data tracks changes due to a change in the width of the magnetic tape caused by a lengthening or shortening of the magnetic tape due to various factors, by rotating the head unit to change the interval between the magnetic elements along the width direction of the magnetic tape, it is possible to make the interval between the magnetic elements and the interval between the data tracks equal. As a result, the respective magnetic elements can be accurately kept on the respective data tracks. Therefore, according to the head apparatus, drive apparatus, and tracking method described above, it is possible to carry out accurate tracking even when the magnetic tape lengthens or shortens.

In the head apparatus described above, the moving mechanism may be constructed so as to hold the head unit in an angled state where a predetermined angle aside from 0° and 90° is made between the second straight line and the first straight line and to be capable of parallel movement of the head unit held in the angled state along the second straight line. Here, as examples, with a construction where the head unit is held in a state where an angle of 0° is made between the straight lines in the initial state, since it will not be possible to further increase the interval between the magnetic elements along the width direction of the magnetic tape after parallel movement of the head unit in such state, there is the problem that it will be difficult to keep the magnetic elements on the respective tracks when the interval between the data tracks is wider than the interval between the magnetic elements. With a construction where the head unit is held in a state where an angle of 90° is made between the straight lines in the initial state, after the head unit has been moved in parallel in such state, there is the problem that it will not be possible to further reduce the interval between the magnetic elements along the width direction of the magnetic tape. On the other hand, with the head apparatus according to the present invention, since the head unit is held in an angled state where the predetermined angle described above is made between the straight lines in the initial state, it will still be possible after parallel movement of the head unit held in such state to both increase and decrease the interval between the magnetic elements along the width direction of the magnetic tape in accordance with the interval between the data tracks. Accordingly, it will still be possible to carry out reliable tracking both when the interval between the data tracks is wider than the interval between the magnetic elements (i.e., when the magnetic tape has lengthened) and when the interval between the data tracks is narrower than the interval between the magnetic elements (i.e., when the magnetic tape has shortened). Also, by parallel moving the head unit that is held in the state where a predetermined angle is made between the straight lines, compared to when a head unit is moved in parallel in a state where an angle of 0° or 90° is made between the straight lines in the initial state, it will be possible to reliably reduce the time taken by the rotational driving process in accordance with the decrease in the amount of rotation during the rotational driving process. In addition, when the angle is an angle aside from 0° and 90° after tracking, by parallel moving the head unit to other data tracks in a state where such angle is maintained, even if tracking is carried out again on the other data tracks, it will be possible to omit the rotational driving process or at least reliably achieve a reduction in the time taken by the rotational driving process.

Also, in the head apparatus described above, the head unit may include detection elements that detect a servo pattern written along a length direction of the magnetic tape and output a detection signal, and the controller may specify the changes in the interval between the data tracks based on the detection signal. With this construction, it is possible to specify changes in the width of the magnetic tape due to lengthening and shortening and changes in the interval between the data tracks that accompany such changes based on the detection signals. Also, as one example, it is possible to carry out accurate tracking by specifying the position of a detection element (i.e., the head unit) along the width direction of the magnetic tape based on the detection signal, positioning the respective magnetic elements substantially on the respective data tracks based on the specified position, and then rotating the head unit so that the strength of the signals outputted from the respective magnetic elements is maximized.

In the head apparatus described above, the head unit may be constructed so that the detection elements are disposed at both ends of the head unit respectively, and the controller may specify the changes in the interval between the data tracks based on the detection signals outputted respectively from the detection elements. With this construction, since it is possible to accurately specify the changes in the width of the magnetic tape due to lengthening and shortening and changes in the interval between the data tracks that accompany such changes based on the detection signals outputted from the detection elements disposed at both ends of the head unit, it is possible to carry out tracking even more accurately.

It should be noted that the disclosure of the present invention relates to a content of Japanese Patent Application 2007-296635 that was filed on 15 Nov. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of a drive apparatus;

FIG. 2 is a diagram useful in explaining the construction of a magnetic tape and how a head unit is disposed;

FIG. 3 is a diagram useful in explaining the construction of the head unit;

FIG. 4 is a table showing the relationship between (i) the angle made between a straight line along the length direction of the head unit and a straight line along the width direction of the magnetic tape and (ii) the distance along the width direction of the magnetic tape from a magnetic element positioned on the very end of the head unit to a magnetic element positioned at the center;

FIG. 5 is a first diagram useful in explaining a tracking method;

FIG. 6 is a table showing the relationship between factors that change the width of the magnetic tape and the respective rates of change;

FIG. 7 is a second diagram useful in explaining the tracking method;

FIG. 8 is a third diagram useful in explaining the tracking method; and

FIG. 9 is a fourth diagram useful in explaining the tracking method.

### DESCRIPTION OF THE PREFERRED EMBODIMENTS

Preferred embodiments of a head apparatus, a drive apparatus and a tracking method according to the present invention will now be described with reference to the attached drawings.

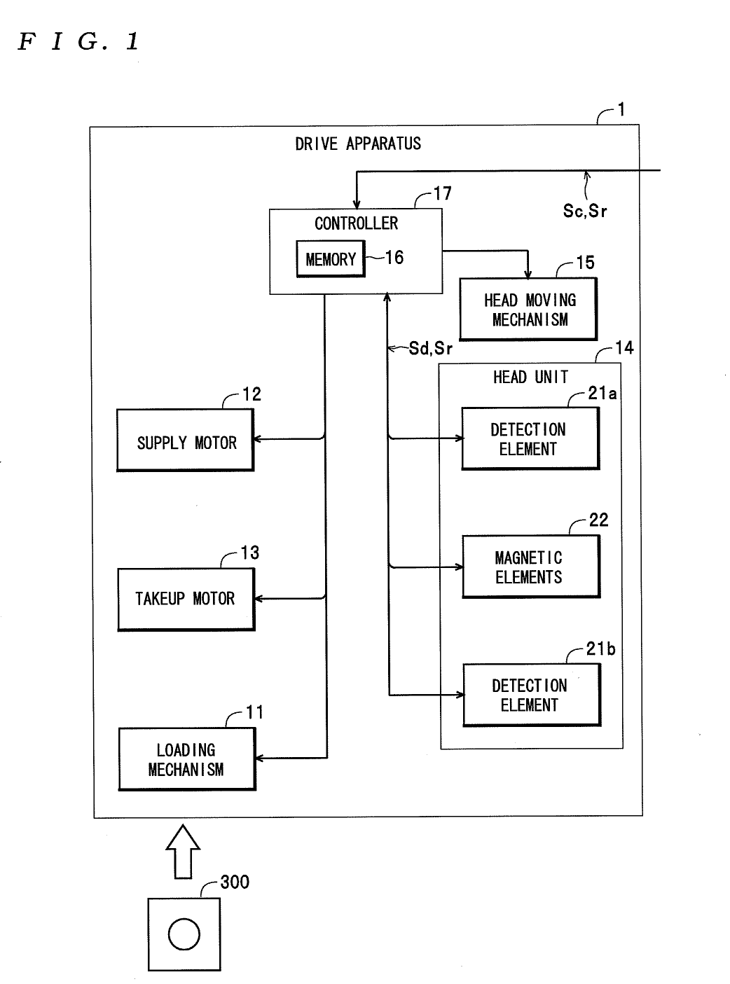

First, the construction of a drive apparatus 1 will be described. The drive apparatus 1 shown in FIG. 1 is one example of a “drive apparatus” according to the present invention and is constructed so as to be capable of recording data on a tape cartridge 300 (i.e., a magnetic tape 301, described later) and/or reproducing data that has been recorded on the tape cartridge 300.

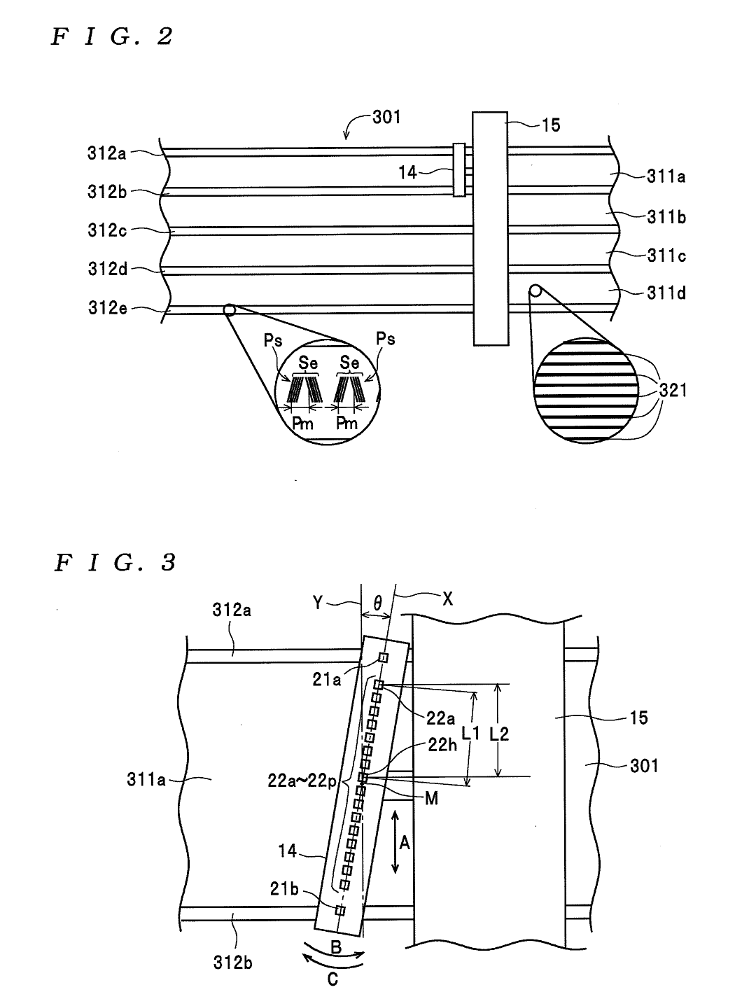

As one example, the tape cartridge 300 is a large-capacity information medium used when backing up data recorded in a computer and as one example is constructed so as to include the magnetic tape 301 that is wound around a single tape reel (not shown). In this case, as shown in FIG. 2, the magnetic tape 301 includes a plurality (in this example, four) of data bands 311a to 311d along the length direction thereof (hereinafter, the data bands 311a to 311d are collectively referred to as the “data bands 311” when no distinction is required), with a plurality (in this example, 176) of data tracks 321 being respectively provided on each of the data bands 311. Also, as shown in FIG. 2, servo bands 312a to 312e (hereinafter, the servo bands 312a to 312e are collectively referred to as the “servo bands 312” when no distinction is required) are provided along the length direction of the magnetic tape 301 at both ends in the width direction of the magnetic tape 301 and between the respective data bands 311. Servo patterns Ps are respectively written along the length direction of the magnetic tape 301 on each of the servo bands 312. When the recording or reproducing of data is carried out on the magnetic tape 301 by the drive apparatus 1, the servo patterns Ps serve as tracking servo patterns used for tracking control of a head unit 14 (see FIG. 2) of the drive apparatus 1. As shown in FIG. 2, as one example each servo pattern Ps is constructed of a plurality of segments (lines) Se, with pairs of facing segments Se being formed so as to become gradually distant from one another toward one end (the lower end in FIG. 2) thereof to form inverted-V shapes.

On the other hand, as shown in FIG. 1, the drive apparatus 1 includes a loading mechanism 11, a supply motor 12, a takeup motor 13, the head unit 14, a head moving mechanism 15, and a controller 17. Here, the head unit 14, the head moving mechanism 15, and the controller 17 construct a “head apparatus” according to the present invention. In accordance with control by the controller 17, the loading mechanism 11 loads the tape cartridge 300 and pulls out the magnetic tape 301 from the tape cartridge 300. The supply motor 12 feeds out the magnetic tape 301 by rotating the tape reel of the tape cartridge 300. The takeup motor 13 rotates a takeup reel, not shown, to wind on the magnetic tape 301. In this case, a “running mechanism” for the present invention is constructed of the supply motor 12 and the takeup motor 13, and by controlling the rotational velocity of the supply motor 12 and the takeup motor 13 using the controller 17, the magnetic tape 301 is run at a predetermined running velocity.

As shown in FIG. 3, the head unit 14 includes detection elements 21a, 21b (hereinafter referred to as the “detection elements 21” when no distinction is required) and a plurality of (for example, 16) magnetic elements 22a to 22p (hereinafter referred to as the “magnetic elements 22” when no distinction is required), and as one example is constructed so as to be rectangular when viewed from above. The detection elements 21a, 21b are disposed at both ends of the head unit 14 and, by detecting the segments Se that construct the servo patterns Ps, output detection signals Sd (see FIG. 1) that can measure a burst interval Pm of the servo patterns Ps (the interval between predetermined segments Se in the servo patterns Ps (see FIG. 2) that is one example of a timing-based servo).

The magnetic elements 22 carry out recording of data and reproducing of recorded data on data tracks 321 provided in a data band 311 on the magnetic tape 301. Also, as shown in FIG. 3, the magnetic elements 22 are disposed at equal intervals with a predetermined pitch on a straight line X (a “first straight line” for the present invention) along the length of the head unit 14. Here, on the head unit 14, the pitch of the magnetic elements 22 is set equal to (or larger than) an estimated maximum for the interval between the data tracks 321 when it is assumed that the interval between the data tracks 321 will widen when the magnetic tape 301 lengthens due to a variety of factors that will be described later. More specifically, on the head unit 14, a distance L1 from the magnetic element 22a positioned on the very end to the magnetic element 22h positioned in the center is set at 1253.6 μm, for example, and the interval of the magnetic elements 22 is set at 179.1 μm (1253.6 μm/7).

The head moving mechanism 15 is a “moving mechanism” for the present invention, and in accordance with control by the controller 17, moves the head unit 14 by carrying out a parallel moving process and a rotational driving process. In the parallel moving process, as shown in FIG. 3, the head moving mechanism 15 moves the head unit 14 (in the direction of the arrow A shown in FIG. 3) along a straight line Y (a “second straight line” for the present invention) that is perpendicular to the data tracks 321 of the magnetic tape 301 and matches the width direction of the magnetic tape 301. Also, as shown in FIG. 3, in the rotational driving process, the head moving mechanism 15 rotates the head unit 14 in the direction of the arrow B (counterclockwise) and in the direction of the arrow C (clockwise) in FIG. 3 about a center portion M so as to increase or decrease the angle 0 between the straight line X and the straight line Y described above. In an initial state, the head moving mechanism 15 holds the head unit 14 so that the angle θ between the straight line X and the straight line Y is kept at a predetermined angle set in advance (as one example, 5°) aside from 0° and 90°, or in other words, holds the head unit 14 in a posture where the straight line X is angled with respect to the straight line Y by the predetermined angle, and in the parallel moving process described above, is capable of moving the head unit 14 in this angled state along the Y direction (such movement is referred to here as “parallel movement”).

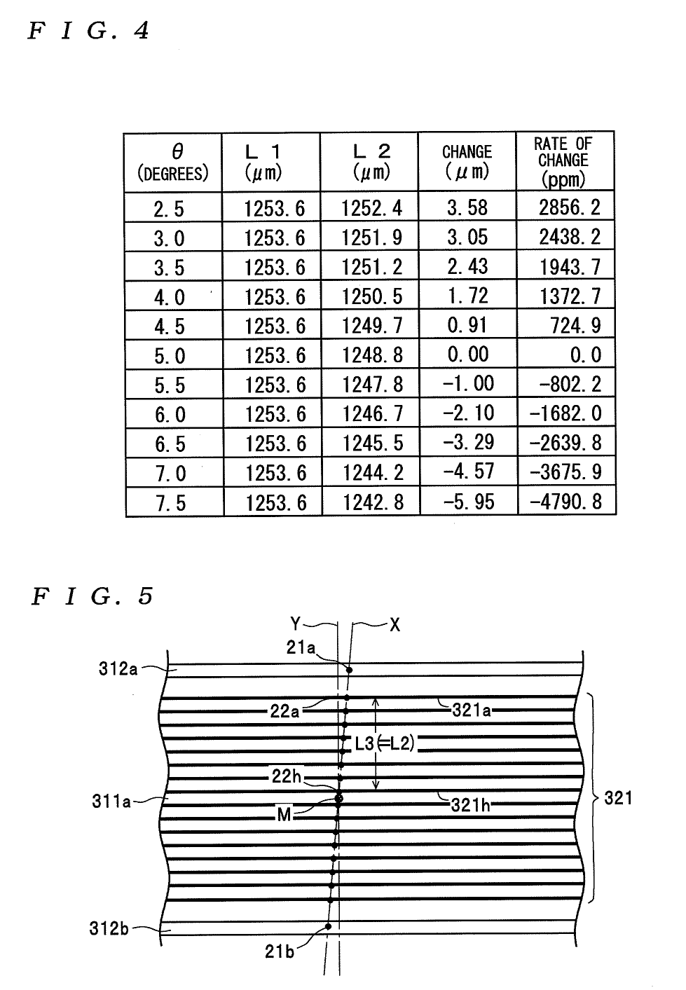

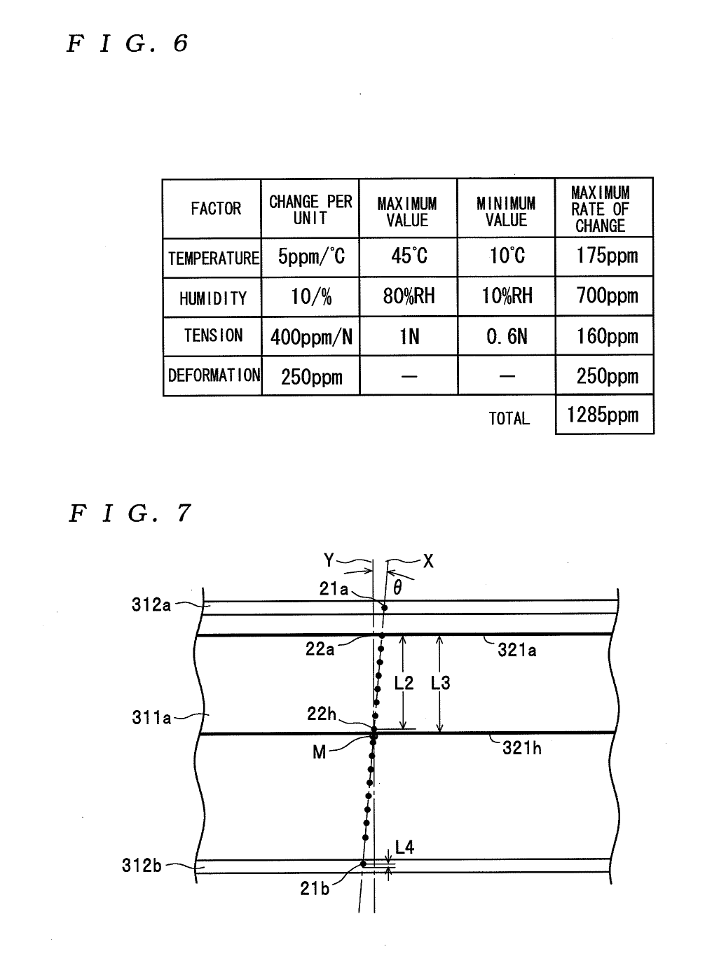

By rotating the head unit 14 to increase or decrease the angle θ between the straight line X and the straight line Y, the distance L2 along the width direction of the magnetic tape 301 (i.e., along the straight line Y) from the magnetic element 22a to the magnetic element 22h changes as shown in FIG. 4. More specifically, as shown in FIG. 4, when the angle θ is 5° (the initial state), for example, the distance L2 is 1248.8 μm, while when the angle θ is reduced to 2.5° from the initial state, the distance L2 increases to 1252.4 μm, and in accordance with this, the interval between the magnetic elements 22 along the width direction of the magnetic tape 301 also increases. Conversely, when the angle θ is increased to 7.5° from the initial state, the distance L2 decreases to 1242.8 μm, and in accordance with this, the interval between the magnetic elements 22 along the width direction of the magnetic tape 301 also decreases.

The controller 17 controls the various units that construct the drive apparatus 1 in accordance with control signals Sc inputted from an external apparatus such as a computer. The controller 17 measures the burst interval Pm based on the detection signals Sd outputted from the detection elements 21 of the head unit 14, temporarily stores the burst interval Pm in an internal memory 16 (see FIG. 1), and also carries out tracking control that keeps the respective magnetic elements 22 on the respective data tracks 321 using the burst interval Pm. In this case, when executing tracking control, the controller 17 carries out the parallel moving process described above for the head moving mechanism 15 and carries out the rotational driving process described above on the head moving mechanism 15 in accordance with changes in the interval between the data tracks 321 that accompany changes in the width of the magnetic tape 301 to keep the respective magnetic elements 22 on the respective data tracks 321.

Next, the operation of the various component elements of the drive apparatus 1 will be described.

For example, when using the drive apparatus 1 to reproduce data that has been recorded on the tape cartridge 300, the tape cartridge 300 is set in the drive apparatus 1. When doing so, the loading mechanism 11 moves the tape cartridge 300 toward a front end portion of a driving shaft, not shown, to clamp the driving shaft and the tape reel of the tape cartridge 300. Next, the loading mechanism 11 pulls the magnetic tape 301 wound around the tape reel out of the tape cartridge 300 and winds the magnetic tape 301 onto the takeup reel.

Next, reproducing of the data is indicated by operating a computer connected to the drive apparatus 1. After this, the controller 17 carries out a reproducing process in accordance with the control signals Sc outputted from the computer. In this reproducing process, the controller 17 first controls the supply motor 12 and the takeup motor 13 to run the magnetic tape 301 at the predetermined running velocity and feeds out and winds on the magnetic tape 301. Next, the controller 17 carries out tracking control. During tracking control, the controller 17 controls the head moving mechanism 15 to carry out the parallel moving process to move the head unit 14 in the direction of the arrow A so that as shown in FIG. 3, the detection element 21a of the head unit 14 is positioned substantially above the servo band 312a and the detection element 21b is positioned substantially above the servo band 312b. At this time, the magnetic elements 22 of the head unit 14 become positioned substantially above the data tracks 321 inside one data band 311 (for example, the data band 311a). Note that the data tracks 321 have been omitted from FIG. 3.

Next, the respective detection elements 21a, 21b detect the segments Se that construct the servo pattern Ps and output detection signals Sd that can measure the burst interval Pm. As one example, the detection signals Sd are signals that show changes in voltage, and whenever a segment Se approaches one of the detection elements 21a, 21b due to movement of the magnetic tape 301, that is, in each period that corresponds to a burst interval Pm, there is a peak in the voltage value of the detection signals Sd. This means that it is possible to measure the burst interval Pm based on the time between such peaks.

Next, based on the time between adjacent peaks in the detection signals Sd and the running velocity of the magnetic tape 301 that is set in advance, the controller 17 measures the burst interval Pm (by multiplying the two values, for example). In this case, each servo pattern Ps is recorded by transferring a pattern of a form and size that are set in advance. This means that the burst interval Pm of one servo pattern Ps, or in other words, the distance between segments Se that construct one servo pattern Ps will be universally specified by the position in the up-down direction (i.e., the width direction of the magnetic tape 301) of the servo pattern Ps. Accordingly, it will be possible to specify the position of the detection element 21a from the burst interval Pm, and to specify the distance between the specified position and a target position to which the detection element 21a should move, that is, the tracking amount for tracking control.

Next, by controlling the head moving mechanism 15 to carry out the parallel moving process, as shown in FIG. 3 the controller 17 has the head unit 14 moved by the tracking amount in the direction of the arrow A. Here, if there has been no lengthening or shortening of the magnetic tape 301 after the recording of data, the interval between the magnetic elements 22 of the head unit 14 will still be the same distance as the interval of the data tracks 321 on which the magnetic elements 22 are to be kept. More specifically, as shown in FIG. 5, a distance L3 from a data track 321a on which the magnetic element 22a is to be kept to the data track 321h on which the magnetic element 22h is to be kept will still be 1248.8 μm that is the same as the distance L2 described above and the interval between the magnetic elements 22 and the interval between the data tracks 321 will both be 178.8 μm (=1248.8 μm/7). This means that by positioning the detection element 21a at the target position, as shown in FIG. 5, the magnetic elements 22 of the head unit 14 will become accurately placed on the data tracks 321 from which data is to be reproduced. Note that for ease of understanding the present invention, the external form of the head unit 14 has been omitted from FIG. 5 and FIGS. 7 to 9 described later.

On the other hand, there are cases where the width of the magnetic tape 301 used in the tape cartridge 300 changes as a result of the magnetic tape 301 lengthening or shortening due to a variety of factors, such as environmental changes in temperature, humidity, and the like and changes in tension applied during use. When the width has changed in this way, a difference is produced between the interval of the magnetic elements 22 of the head unit 14 and the interval of the respective data tracks 321 on which the respective magnetic elements 22 are to be kept. More specifically, as examples, the width of the magnetic tape 301 may change with a maximum rate of around 175 ppm, around 700 ppm, around 160 ppm, and around 250 ppm, respectively due to changes in temperature, changes in humidity, changes in tension, and deformation of the magnetic tape 301. When such factors coincide, the rate of change in the width of the magnetic tape 301 can increase by up to around 1285 ppm (around 0.13%), and in this state, the distance L3 described above from the data track 321a to the data track 321h changes by around 1.6 μm (=1248.8 μm×1285 ppm≈1.6 μm) compared to when there is no lengthening or shortening, thereby producing a difference of around 1.6 μm between the distance L2 and the distance L3 described above, or in other words, a difference of 0.23 μm (1.6 μm/7) between the interval of the magnetic elements 22 and the interval of the data tracks 321. Accordingly, to carry out accurate tracking on a magnetic tape 301 that has greatly changed in this way, the parallel moving process described above will not be sufficient by itself. For this reason, the controller 17 carries out the following processing after the parallel moving process described above has been completed.

More specifically, after the parallel moving process has been completed, the controller 17 measures the burst interval Pm of the servo patterns Ps recorded in the servo band 312b based on the detection signals Sd outputted from the detection element 21b. After this, the controller 17 specifies the position of the detection element 21b based on the measured burst interval Pm and specifies the distance L4 between such position and a target position at which the detection element 21b should be positioned. Here, since the detection element 21a has moved to its target position in the parallel moving process described above, the width of the magnetic tape 301 will have changed by the distance L4 (or substantially the distance L4). Next, the controller 17 specifies the angle θ at which the interval between the magnetic elements 22 becomes equal to the interval between the data tracks 321 based on the distance L4 and then controls the head moving mechanism 15 to carry out the rotational driving process and thereby rotate the head unit 14 to produce the specified angle θ.

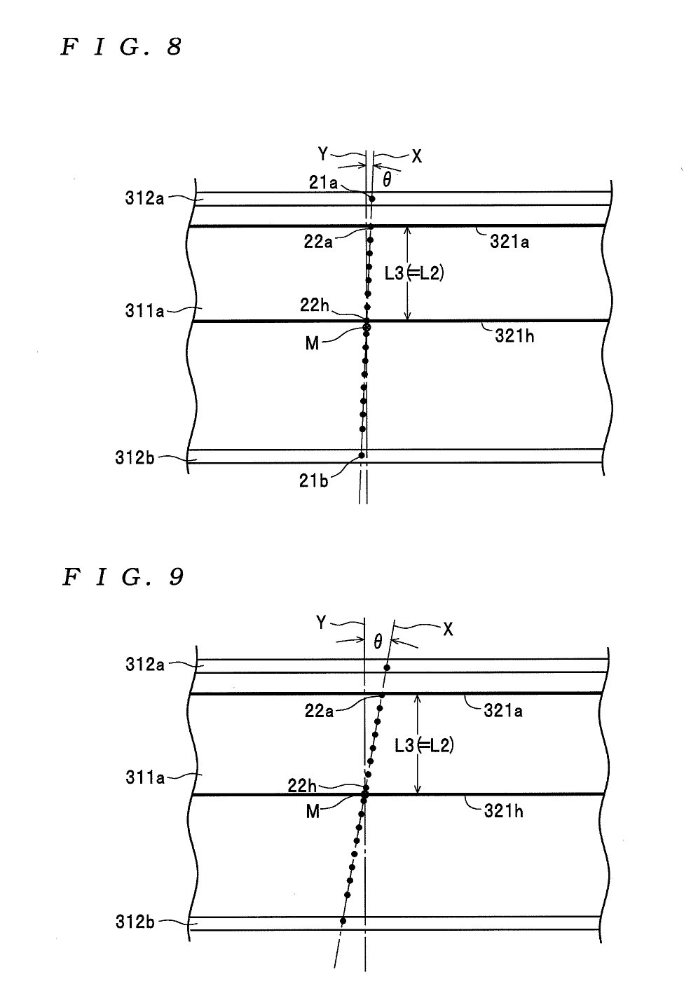

Here, as one example, when the magnetic tape 301 has lengthened and the distance L3 described above is 1251.2 μm, by rotating the head unit 14 so that the angle θ decreases from the initial state of 5° to 3.5°, the distance L2 and the distance L3 are made equal (see FIG. 4). Accordingly, the interval between the magnetic elements 22 in the width direction of the magnetic tape 301 becomes equal to the interval between the data tracks 321. Accordingly, when the magnetic tape 301 has lengthened and the interval between the data tracks 321 has widened, as shown in FIG. 8, the controller 17 causes the head moving mechanism 15 to carry out the rotational driving process to reduce the angle θ from the initial state of 5°.

On the other hand, when the magnetic tape 301 has shortened and the distance L3 described above is 1245.5 μm, by rotating the head unit 14 so that the angle θ increases from the initial state of 5° to 6.5°, the distance L2 and the distance L3 are made equal (see FIG. 4). Accordingly, the interval between the magnetic elements 22 in the width direction of the magnetic tape 301 becomes equal to the interval between the data tracks 321. Accordingly, when the magnetic tape 301 has shortened and the interval between the data tracks 321 has narrowed, as shown in FIG. 9, the controller 17 causes the head moving mechanism 15 to carry out the rotational driving process to increase the angle θ from the initial state of 5°.

Since the positions of the magnetic elements 22 relative to the data tracks 321 will have been shifted either up or down in the width direction of the magnetic tape 301 due to rotation of the head unit 14, after completing the rotational driving process, the controller 17 specifies a tracking amount based on the detection signal Sd outputted from the detection element 21a (or the detection element 21b) and carries out the parallel moving process described above once again. In this case, due to the rotational driving process described above, the interval between the magnetic elements 22 along the width direction of the magnetic tape 301 and the interval between the data tracks 321 will be equal. For this reason, as shown in FIGS. 8 and 9, even if the width of the magnetic tape 301 has changed, the magnetic elements 22 of the head unit 14 will be accurately kept on the respective data tracks 321 where data is to be reproduced, and as a result, the data recorded on the respective data tracks 321 can be stably reproduced.

While carrying out the tracking control described above, the controller 17 outputs the reproduction signals Sr outputted from the magnetic elements 22 to a computer. At a point when the magnetic tape 301 has been entirely wound around the takeup reel, for example, the controller 17 controls (i.e., stops) the operation of the motors 12, 13 to stop the running, feeding out, and winding on of the magnetic tape 301. After this, the controller 17 controls the head moving mechanism 15 to move the head unit 14 downward in FIG. 3 along the width direction of the magnetic tape 301 (in the direction of the arrow A in FIG. 3) by a predetermined distance. When doing so, the head moving mechanism 15 moves the head unit 14 while keeping the angle θ constant after rotation by the rotational driving process described above. Next, by controlling the motors 12, 13, the magnetic tape 301 is moved in the reverse direction to the first direction of movement. After this, the controller 17 carries out the tracking control described above and outputs the reproduction signals Sr outputted from the magnetic elements 22 of the head unit 14 to the computer. Next, the controller 17 carries out the reproducing process described above a predetermined number of times, and by moving the head unit 14 back and forth relative to the magnetic tape 301 multiple times, the data recorded on the plurality (in this example, 176) of data tracks 321 on a data band 311 on the magnetic tape 301 is reproduced.

On the other hand, when data is recorded on the tape cartridge 300 using the drive apparatus 1, after the tape cartridge 300 has been set in the drive apparatus 1, the computer is operated to indicate the recording of data. When doing so, the controller 17 carries out the tracking control described above. In this case also, accurate tracking can be carried out in the same way as in the reproducing process described above.

In this way, according to the drive apparatus 1 and the tracking method described above, the head unit 14 is rotated in accordance with the change in the interval between the data tracks 321 that accompanies a change in width of the magnetic tape 301. This means that even if the width of the magnetic tape 301 changes in accordance with a lengthening or shortening of the magnetic tape 301 due to various factors, by rotating the head unit 14 to change the interval between the magnetic elements 22 along the width direction of the magnetic tape 301, it is possible to make the interval between the magnetic elements 22 and the interval between the data tracks 321 equal. As a result, the respective magnetic elements 22 can be accurately kept on the respective data tracks 321. Therefore, according to the drive apparatus 1 and the tracking method, it is possible to carry out accurate tracking even when the magnetic tape 301 lengthens and shortens.

Also, in this drive apparatus 1, the head moving mechanism 15 is constructed so as to be capable of moving the head unit 14 in parallel along the straight line Y while holding the head unit in a state where predetermined angle aside from 0° and 90° is made between the straight line X and the straight line Y. In this case, with a construction where the head unit 14 is held in a state where an angle of 0° is made between the straight lines X and Y in the initial state, for example, since it will not be possible to further increase the interval between the magnetic elements 22 along the width direction of the magnetic tape 301 after parallel movement of the head unit 14 in this state, there is the problem that it will be difficult to keep the magnetic elements 22 on the respective tracks when the interval between the data tracks 321 is wider than the interval between the magnetic elements 22. Also, with a construction where the head unit 14 is held in a state where an angle of 90° is made between the straight lines X and Y in the initial state, after parallel movement of the head unit 14 in this state, there is the problem that it will not be possible to further reduce the interval between the magnetic elements 22 along the width direction of the magnetic tape 301. On the other hand, with the drive apparatus 1 according to the present invention, since the head unit 14 is held in a state where the predetermined angle described above is made between the straight lines X, Y in the initial state, it will still be possible after parallel movement of the head unit 14 held in this state to both increase and decrease the interval between the magnetic elements 22 along the width direction of the magnetic tape 301 in accordance with the interval between the data tracks 321. Accordingly, it will be possible to carry out reliable tracking both when the interval between the data tracks 321 is wider than the interval between the magnetic elements 22 (i.e., when the magnetic tape 301 has lengthened) and when the interval between the data tracks 321 is narrower than the interval between the magnetic elements 22 (i.e., when the magnetic tape 301 has shortened). Also, by parallel moving the head unit 14 that is held in the state where the predetermined angle described above is made between the straight lines X and Y, compared to when a head unit 14 is moved in parallel in a state where an angle of 0° or 90° is made between the straight lines X, Y in the initial state, it will be possible to reliably reduce the time taken by the rotational driving process in accordance with the decrease in the amount of rotation during the rotational driving process. In addition, when the angle θ is an angle aside from 0° and 90° after tracking, by parallel moving the head unit 14 to other data tracks 321 in a state where the angle θ is maintained, even if tracking is carried out again on the other data tracks 321, it will be possible to omit the rotational driving process or at least reliably achieve a reduction in the time taken by the rotational driving process.

Also, with the drive apparatus 1, the head unit 14 is constructed so as to include the detection elements 21 that detect the servo patterns Ps written on the magnetic tape 301 and output the detection signals Sd. Therefore, according to the drive apparatus 1, it is possible to specify changes in the width of the magnetic tape 301 due to lengthening and shortening and changes in the interval between the data tracks 321 that accompany such changes based on the detection signals Sd.

In the drive apparatus 1, the head unit 14 is constructed with the detection elements 21 disposed at both ends. Therefore, according to the drive apparatus 1, since it is possible to accurately specify the changes in the width of the magnetic tape 301 due to lengthening and shortening and changes in the interval between the data tracks 321 that accompany such changes based on the detection signals Sd outputted from the detection elements 21 disposed at both ends of the head unit 14, it is possible to carry out tracking even more accurately.

Note that the present invention is not limited to the construction described above. For example, although an example of a head unit 14 where two detection elements 21a, 21b are disposed at both ends has been described, the number of detection elements 21 is not limited to two, and it is possible to use a head unit equipped with an arbitrary number of (i.e., one or more) detection elements 21. In such case, the disposed positions of the detection elements 21 are not limited to both ends of the head unit 14 and can be set at arbitrary positions on the head unit 14. In addition, although an example has been described where the head moving mechanism 15 holds the head unit 14 so that the angle θ between the straight line X and the straight line Y is 5° in the initial state, it should be obvious that the angle θ in the initial state is not limited to 5° and can be set at an arbitrary angle.

Although an example has been described where the controller 17 carries out tracking control using the burst interval Pm measured based on the detection signals Sd outputted from the detection elements 21a, 21b, it is also possible to use a construction that carries out tracking control without using the burst interval Pm (the detection signals Sd). More specifically, it is possible to carry out tracking by measuring changes in the strength of the signals respectively outputted from the magnetic elements 22 when the head unit 14 is rotated relative to the head moving mechanism 15 and to stop rotation of the head unit 14 when the strength of the signals is maximized. With this construction, it is possible to carry out accurate tracking on the magnetic tape 301 even when the servo patterns Ps have not been written on the magnetic tape 301.

What is claimed is:

1. A head apparatus comprising:
a head unit where a plurality of magnetic elements, which respectively carry out at least one of reproducing of data recorded on a plurality of data tracks provided on a magnetic tape and recording of data on the data tracks, are disposed at equal intervals on a first straight line;
a moving mechanism that moves the head unit; and
a controller that carries out tracking control to cause the moving mechanism to move the head unit so that the respective magnetic elements are kept on the respective data tracks, wherein the moving mechanism is capable of rotational driving that rotates the head unit in a direction so as to increase or decrease an angle between a second straight line along a width of the magnetic tape and the first straight line, and when carrying out the tracking control, the controller causes the moving mechanism to rotationally drive the head unit so as to increase or decrease the angle in accordance with changes in an interval between the data tracks so as to keep the respective magnetic elements on the respective data tracks.

2. The head apparatus according to claim 1,
wherein the moving mechanism is constructed so as to hold the head unit in an angled state where a predetermined angle aside from 0° and 90° is made between the second straight line and the first straight line and to be capable of parallel movement of the head unit held in the angled state along the second straight line.

3. The head apparatus according to claim 1,
wherein the head unit includes detection elements that detect a servo pattern written along a length direction of the magnetic tape and output a detection signal, and
the controller specifies the changes in the interval between the data tracks based on the detection signal.

4. The head apparatus according to claim 3,
wherein the detection elements are disposed at both ends of the head unit respectively, and
the controller specifies the changes in the interval between the data tracks based on the detection signals respectively outputted from the detection elements.

5. A drive apparatus comprising:
the head apparatus according to claim 1; and
a running mechanism that runs the magnetic tape,
wherein the controller carries out the tracking control in a state where the magnetic tape is being run by the running mechanism.

6. A tracking method that moves a head unit with a plurality of magnetic elements, which respectively carry out at least one of reproducing of data recorded on a plurality of data tracks provided on a magnetic tape and recording of data on the data tracks, disposed at equal intervals on a first straight line so as to keep the respective magnetic elements on the respective data tracks,
the tracking method comprising rotationally driving the head unit in a direction so as to increase or decrease an angle between a second straight line along a width of the magnetic tape and the first straight line by an amount in keeping with a change in an interval between the data tracks so as to keep the respective magnetic elements on the respective data tracks.
